(19) United States
(12) Patent Application Publication
(10) Pub. No.: US 2024/0365864 A1
(43) Pub. Date: Nov. 7, 2024

(54) A PRODUCT FOR STORING AND DISPENSING CONSUMABLES FOR USE WITH AN AEROSOL PROVISION DEVICE

(71) Applicant: NICOVENTURES TRADING LIMITED, London (GB)

(72) Inventor: John RICHARDSON, London (GB)

(21) Appl. No.: 18/681,135

(22) PCT Filed: Aug. 4, 2022
(86) PCT No.: PCT/EP2022/071991

§ 371 Date: Feb. 5, 2024

(51) Int. Cl. A24F 40/42; A24F 40/20; A24F 40/30; A24F 40/465; A24F 40/70; H05B 6/10

(52) U.S. Cl. CPC A24F 40/42; A24F 40/20; A24F 40/30; A24F 40/465; A24F 40/70; H05B 6/105

(57) ABSTRACT

A product for storing and dispensing two or more consumable elements for use with a non-combustible aerosol provision system is provided. The product includes two or more consumable elements and a carrier, and the consumable elements are supported on the carrier. The product is reversibly configurable between a packed configuration and one or more dispensing configurations. The packed configuration is one in which the consumable elements cannot be removed from the product and a dispensing configuration is a configuration in which a consumable element may be removed from the product.

### RELATED APPLICATIONS

The present application is a National Phase entry of PCT Application PCT/EP2022/071991 filed Aug. 4, 2022, which claims priority to GB Application No. 2111252.9 filed Aug. 4, 2021 and GB Application No. 2118575.6 filed Dec. 20, 2021, all of which are hereby incorporated by reference in their entirety.

### TECHNICAL FIELD

This disclosure relates to the field of non-combustible aerosol-provision systems, in particular to a product which stores and dispenses consumables for use with an aerosol provision device, a method for manufacturing the product, and an aerosol provision system including a consumable and an aerosol provision device.

### BACKGROUND

Smoking articles such as cigarettes, cigars and the like burn tobacco during use to create tobacco smoke. Alternatives to these types of articles release an inhalable aerosol or vapor by releasing compounds from a substrate material by heating without burning. These may be referred to as non-combustible smoking articles, aerosol generating assemblies, or aerosol provision devices.

One example of such a product is a heating device which release compounds by heating, but not burning, an aerosolizable material which may be referred to as a solid aerosol-generating material. This solid aerosol-generating material may, in some cases, contain a tobacco material. The heating volatilizes at least one component of the material, typically forming an inhalable aerosol. These products may be referred to as heat-not-burn devices, tobacco heating devices or tobacco heating products. Various different arrangements for volatilizing at least one component of the solid aerosol-generating material are known.

As another example, there are hybrid devices. These hybrid devices contain a liquid source (which may or may not contain nicotine) which is vaporized by heating to produce an inhalable vapor or aerosol. The device additionally contains a solid aerosol-generating material (which may or may not contain a tobacco material) and components of this material are entrained in the inhalable vapor or aerosol to produce the inhaled medium.

### SUMMARY

According to a first aspect of the present disclosure there is provided a product for storing and dispensing two or more consumable elements for use with a non-combustible aerosol provision system, in which
the product comprises two or more consumable elements and a carrier,
the consumable elements are supported on the carrier,
the product is reversibly configurable between in a packed configuration and one or more dispensing configurations,
the packed configuration is one in which the consumable elements cannot be removed from the product,
a dispensing configuration is a configuration in which a consumable element may be removed from the product.

According to a second aspect of the present disclosure there is provided a method of making a product according to the first aspect of the present disclosure in which the method comprises
(a) providing a carrier, and
(b) forming at least one consumable element on the carrier.

According to a third aspect of the present disclosure there is provided a method of making a product according to the first aspect of the present disclosure in which the method comprises
(a) providing a carrier, and
(b) adhering at least one preformed consumable element to the carrier.

According to a fourth aspect of the present disclosure there is provided a kit for making a consumable for use with an apparatus for heating an aerosol generating material in which the kit comprises at least one support and at least one product according to the first aspect of the present disclosure.

According to a fifth aspect of the present disclosure there is provided a method of making a consumable for use with an apparatus for heating an aerosol generating material in which the method comprises
(a) removing a consumable element from a product according to the first aspect of the present disclosure, and
(b) attaching the consumable element to a support.

According to a sixth aspect of the present disclosure there is provided an aerosol provision system comprising an aerosol provision device and a kit according to the third aspect of the present disclosure, in which the aerosol provision device comprises a aerosol generator configured to heat at least a portion of the aerosol generating material supported on a consumable, and the consumable is made using the kit and the method of the fourth and fifth aspects of the present disclosure.

According to a seventh aspect of the present disclosure there is provided a method of generating aerosol from a consumable made using the kit and the method of the fourth and fifth aspects of the present disclosure, the method including using an aerosol generating device with at least one aerosol generator disposed to heat, but not burn, the consumable in use; wherein at least one aerosol generator is a resistive heater element or a magnetic field generator and a susceptor.

Further features and advantages of the present disclosure will become apparent from the following description of embodiments of the disclosure given by way of example and with reference to the accompanying drawings.

### DRAWINGS

FIG. 1 shows a first embodiment of a product according to the present disclosure in a packed configuration;

FIG. 2 shows a section of the product of FIG. 1 along the section line E-E′;

FIG. 3 shows an embodiment of a consumable element of the product of FIG. 1;

FIG. 4 shows the product of FIG. 1 in a dispensing configuration;

FIG. 5 shows a schematic view of an embodiment of an aerosol provision device for use with a consumable including a consumable element of FIG. 3 once that consumable element has been removed from the product of FIG. 1;

FIG. 6 shows a section of a second embodiment of a product according to the present disclosure along a section line equivalent to the section line E-E′ of FIG. 1;

FIG. 7 shows a section of a third embodiment of a product according to the present disclosure along a section line equivalent to the section line E-E′ of FIG. 1;

FIG. 8 shows a fourth embodiment of a product according to the present disclosure before being configured into a packed configuration;

FIG. 9 shows a section of the product of FIG. 8 along section-lines F-F′ and H-H′;

FIG. 10 shows a section of the product of FIG. 8 along section-lines G-G′;

FIG. 11 shows a perspective view of the product of FIG. 8;

FIG. 12 shows a side view of the product of FIG. 8 in a storage configuration;

FIG. 13 shows an embodiment of a consumable element of the product of FIG. 8; and

FIG. 14 shows a side view of the product of FIG. 8 in a dispensing configuration.

### DETAILED DESCRIPTION

The consumable of the present description may be alternatively referred to as an article.

In some embodiments, the consumable comprises aerosol-generating material. The consumable may comprise an aerosol-generating material storage area, an aerosol-generating material transfer component, an aerosol generator, an aerosol generation area, a housing, a wrapper, an aerosol-modifying agent, one or more active constituents, one or more flavors, one or more aerosol-former materials, and/or one or more other functional materials.

The apparatus for heating the aerosol-generating material with which the consumable is to be used is a part of a non-combustible aerosol provision system. Non-combustible aerosol provision systems release compounds from an aerosol-generating material without combusting the aerosol-generating material, such as electronic cigarettes, tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

According to a first aspect of the present disclosure there is provided a product for storing and dispensing two or more consumable elements for use with a non-combustible aerosol provision system, in which
the product comprises two or more consumable elements and a carrier,
the consumable elements are supported on the carrier,
the product is reversibly configurable between in a packed configuration and one or more dispensing configurations,
the packed configuration is one in which the consumable elements cannot be removed from the product,
a dispensing configuration is a configuration in which a consumable element may be removed from the product.

In some embodiments of the above embodiment a consumable comprises at least one consumable element and at least one other element, for example a support. In some embodiments of the above embodiment a consumable consists of a consumable element.

In an embodiment of any of the above embodiments the consumable elements are releasable from the carrier. In some embodiments they are releasable without damage to the consumable elements.

In an embodiment of the above embodiment the carrier is formed of a sheet material.

In an embodiment of any of the above embodiments the carrier is a longitudinally extending strip of material.

In an embodiment of any of the above embodiments the carrier is a material which is capable of bending without breaking.

In an embodiment of any of the above embodiments the carrier material comprises at least one of paper, card, plastics or metallic foil.

In an embodiment of any of the above embodiments at least a portion of the carrier both overlies an overlain portion of the carrier and is overlaid by an overlying portion of the carrier when the product is in the packed configuration.

In an embodiment of any of the above embodiments the packed configuration of the product comprises the carrier wound around an inner support, in which the carrier is wound around the inner support at least twice, or at least three times.

In an embodiment of any of the above embodiments the packed configuration of the product comprises the carrier wound around a void, in which the carrier is wound around the void at least twice, or at least three times.

In an embodiment of any of the above embodiments the packed configuration of the product comprises the carrier wound around an end portion of the carrier, in which the carrier is wound around the end portion at least twice, or at least three times.

In an embodiment of any of the above embodiments the winding of the carrier is in the form of a spiral or coil.

In an embodiment of any of the above embodiments the packed configuration of the product comprises two or more fold lines in the carrier and a panel between each adjacent pair of fold lines, and the carrier is folded into a concertina configuration.

In an embodiment of any of the above embodiments the carrier comprises at least one blank portion on which no consumable elements are supported, and each blank portion overlies a portion of the carrier on which consumable elements are supported when the product is in the packed configuration.

In an embodiment of any of the above embodiments the consumable elements cannot be removed from the product because the carrier prevents a user being able to access to the consumable elements.

In an embodiment of any of the above embodiments the carrier overlies the consumable elements.

An advantage of all the above packed configurations is that the carrier protects the consumable elements from physical damage. Such damage may take the form of unintentional displacement of a consumable element from the carrier, or damage to a consumable element. Unintentional displacement will lead to the consumable element not being available to an intended user of a consumable including that consumable element. Damage to the consumable element may lead to incorrect functioning of the consumable including that consumable element and/or the experience of using the consumable including that consumable element being different to that which is intended.

The carrier also protects the consumable element from contamination. Such contamination may be chemical or biological in nature and may occur as a result of contact with a consumable element by a user or other human or an object. Contamination is undesirable because the contaminants may be entrained in the aerosol generated by the consumable element when it is used. In such circumstances the contamination may be taken into the user along with the aerosol. Additionally or alternatively, such contamination may affect the generation of the aerosol by the consumable element.

In an embodiment of any of the above embodiments a dispensing configuration of the product is a configuration in which a portion of the carrier which supports at least one consumable element is one or both of not overlain by an overlying portion of carrier and does not overlie an overlain portion of carrier.

In an embodiment of any of the above embodiments the product may be reconfigured back to the packed configuration after it has been configured into a dispensing configuration and a consumable element removed from the carrier.

It is to be understood that when the product is in a dispensing configuration a portion, possibly a significant portion, of the product remains in the packed configuration. In some embodiments the packed configuration is such that a user who is removing consumable elements from the product when they are to be used is will find it easiest to remove the consumable elements in a predetermined order, for example from one end to the other end of a longitudinal carrier.

In an embodiment of any of the above embodiments the product further comprises a barrier material, and the barrier material is located between overlying portions of the carrier when those portions are in the packed configuration. In some embodiments the barrier material is a material to which aerosol generating material may only weakly adhere. For the purposes of the present disclosure, adhesion to the barrier material may be considered to be weak adhesion if aerosol generating material which is adhered to both the barrier material and another surface adheres more strongly to the other surface than it adheres to the barrier material.

In an embodiment of any of the above embodiments the product comprises at least one set of perforations, the perforations extend through at least the carrier, and the perforations of at least one set are so arranged that the perforations form a line along which the carrier may be torn. In some embodiments the line of perforations does not cross any consumable element supported on the carrier. In some embodiments the line of perforations crosses at least one consumable element, the perforations extend through the consumable element where the line crosses the consumable element, and the consumable element is torn when the carrier is torn along the line of perforations.

In an embodiment of any of the above embodiments the perforations of at least one set of perforations are so configured that tearing of the carrier along the set of perforations separates a portion of the carrier from the remaining carrier.

In an embodiment of any of the above embodiments the perforations of at least one set of perforations are so configured that tearing of the carrier along the set of perforations separates a portion of carrier which supports at least one consumable element from the rest of the carrier.

In an embodiment of any of the above embodiments at least one consumable element comprises at least one discrete portion of aerosol generating material.

In an embodiment of the above embodiment, the aerosol generating material has the form of an aerosol generating film.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise one or more active substances and/or flavors, one or more aerosol-former materials, and optionally one or more other functional material.

The aerosol-generating material may comprise a binder, such as a gelling agent, and an aerosol former. Optionally, a substance to be delivered and/or filler may also be present.

Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present.

The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be formed by combining a binder, such as a gelling agent, with a solvent, such as water, an aerosol-former and one or more other components, such as one or more substances to be delivered, to form a slurry and then heating the slurry to volatilize at least some of the solvent to form the aerosol-generating film.

The slurry may be heated to remove at least about 60 wt %, 70 wt %, 80 wt %, 85 wt % or 90 wt % of the solvent.

The aerosol-generating material may comprise or be an “amorphous solid”. In some embodiments, the aerosol-generating material comprises an aerosol-generating film that is an amorphous solid. The amorphous solid may be a “monolithic solid”. The amorphous solid may be substantially non-fibrous. In some embodiments, the amorphous solid may be a dried gel. The amorphous solid is a solid material that may retain some fluid, such as liquid, within it. In some embodiments, the amorphous solid may, for example, comprise from about 50 wt %, 60 wt % or 70 wt % of amorphous solid, to about 90 wt %, 95 wt % or 100 wt % of amorphous solid.

The amorphous solid may be substantially free from botanical material. The amorphous solid may be substantially tobacco free.

In an embodiment of any of the above embodiments at least one consumable element comprises at least two discrete portions of aerosol generating material, and at least two discrete portions of aerosol generating material have different compositions to each other. This has the advantage that a user of a consumable including that consumable element may have different experiences when different discrete portions of aerosol generating material on the consumable element are aerosolized.

In an embodiment of any of the above embodiments at least one consumable element comprises a support, and the support supports the aerosol generating material.

The support may be of a material suitable to form a substrate. The support may, for example, be or comprise paper, card, paperboard, cardboard, reconstituted material, a plastics material, a ceramic material, a composite material, glass, a metal, or a metal alloy.

In an embodiment of any of the above embodiments the support comprises a plastics material which can withstand the temperatures typically encountered in a non-combustible aerosol provision device. In some embodiments the support comprises polyether ether ketone (PEEK). Such embodiments have the advantage that the support may be reused, and that a consumable including that consumable element is less affected by any condensation in the non-combustible aerosol provision device than consumables that comprise a support which includes use of a sorbent material for structural purposes.

In an embodiment of any of the above embodiments at least a portion of the support is releasably attached to a portion of the carrier.

In an embodiment of any of the above embodiments the support is a sheet material and the aerosol generating material is an aerosol generating material film.

In an embodiment of any of the above embodiments, the support is a metal foil or a metallic foil.

In an embodiment of any of the above embodiments the aerosol generating material substantially covers or wholly covers one surface of the support.

In an embodiment of any of the above embodiments, the aerosol generating material substantially covers or wholly covers one surface of the support.

In an embodiment of any of the above embodiments, there is provided a product for storing and dispensing two or more consumable elements for use with a non-combustible aerosol provision system, in which
the product comprises two or more consumable elements and a carrier,
the consumable elements are supported on the carrier,
at least one consumable element comprises a support and the support supports at least one discrete portion of aerosol generating material film,
the support is a sheet material,
the product is reversibly configurable between a packed configuration and one or more dispensing configurations,
the packed configuration is one in which the consumable elements cannot be removed from the product,
a dispensing configuration is a configuration in which a consumable element may be removed from the product.

In an embodiment of any of the above embodiments the consumable element is comprised of an aluminium foil support and the aerosol generating material is an aerosol generating material film that covers the whole of one major surface of the support. The other major surface of the support is adapted to attach to the carrier. A major surface of the support is a surface whose width and breadth is greater than the thickness of the support.

In an embodiment of any of the above embodiments, the consumable element may be manufactured separately and applied to the carrier when required. This is advantageous because the manufacturing rate of the product of the present disclosure and the consumable elements that are attached to the product may be significantly different. In particular the formation of the aerosol generating material film can take much longer than it takes to apply a consumable element to the product. Separating the manufacture of the consumable element and the product has the effect that if required multiple apparatus can be used to make the consumable element which are used by a smaller number of apparatus to make the product of the present disclosure.

In an embodiment of any of the above embodiments at least one portion of aerosol generating material is supported on the support, and at least one portion of the aerosol generating material is located between the support and the portion of the carrier which supports the consumable element. This has an advantage that, when the product is in the dispensing configuration, the aerosol generating material which is located between the support and the portion of the carrier on which the support/consumable element is supported is protected from physical damage or contamination.

In an embodiment of any of the above embodiments at least one portion of aerosol generating material is supported on the support, and the support is between at least one portion of the aerosol generating material and the portion of the carrier which supports the consumable element.

In an embodiment of any of the above embodiments the consumable comprises a susceptor.

In an embodiment of any of the above embodiments the support comprises the susceptor.

In an embodiment of any of the above embodiments the carrier comprises the susceptor.

In an embodiment of any of the above embodiments the susceptor comprises a metallic foil.

A susceptor is a material that is heatable by penetration with a varying magnetic field, such as an alternating magnetic field. The susceptor may be an electrically-conductive material, so that penetration thereof with a varying magnetic field causes induction heating of the susceptor by resistive heating as a result of electric eddy currents. The susceptor may be magnetic material, so that penetration thereof with a varying magnetic field causes magnetic hysteresis heating of the susceptor. The susceptor may be both electrically-conductive and magnetic, so that the susceptor is heatable by both heating mechanisms. The device that is configured to generate the varying magnetic field is referred to as a magnetic field generator.

The susceptor may comprise a metal or metal alloy. The susceptor may comprise a ferromagnetic metal such as iron or an iron alloy such as steel or an iron nickel alloy. Some example ferromagnetic metals are a 400 series stainless steel such as grade 410 stainless steel, or grade 420 stainless steel, or grade 430 stainless steel, or stainless steel of similar grades. Alternatively, the susceptor may comprise a suitable non-magnetic, in particular paramagnetic, conductive material, such as aluminium. In a paramagnetic conductive material inductive heating occurs solely by resistive heating due to eddy currents. Alternatively, the susceptor may comprise a non-conductive ferrimagnetic material, such as a non-conductive ferrimagnetic ceramic. In that case, heat is only generated by hysteresis losses. The susceptor may comprise a commercial alloy like Phytherm 230 (with a composition (in % by weight=wt %) with 50 wt % Ni, 10 wt % Cr and the rest Fe) or Phytherm 260 (with a composition with 50 wt % Ni, 9 wt % Cr and the rest Fe).

The susceptor may in some embodiments of any of the above embodiments be a metal foil or film, optionally an aluminium foil or film or a ferrous foil or film. Alternatively, the susceptor may in some embodiments of any of the above embodiments be any conductor that could be sprayed or vapor deposited on a material that forms the support.

In an embodiment of any of the above embodiments the support is a laminate, and at least one layer of the laminate is a susceptor.

In an embodiment of any of the above embodiments at least one of the consumable elements is supported on the carrier by adhesion.

In an embodiment of any of the above embodiments the adhesion is caused by a releasable adhesive.

In an embodiment of any of the above embodiments the releasable adhesive is a pressure sensitive adhesive.

In an embodiment of any of the above embodiments the carrier has at least one carrier attachment surface to which at least one consumable element is attached, the consumable element has a consumable element attachment surface which is attached to the carrier attachment surface, and the carrier attachment surface and consumable element attachment surface have surface characteristics which result in the cause for the adhesion of the consumable element to the carrier remaining on the carrier attachment surface when the consumable element is removed from the carrier attachment surface.

In an embodiment of any of the above embodiments the carrier has at least one carrier attachment surface to which at least one consumable element is attached, the consumable element has a consumable element attachment surface which is attached to the carrier attachment surface, and the carrier attachment surface and consumable element attachment surface have surface characteristics which result in the cause for the adhesion of the consumable element to the carrier remaining on the consumable element attachment surface when the consumable element is removed from the carrier attachment surface.

According to a second aspect of the present disclosure there is provided a method of making a product according to the first aspect of the present disclosure in which the method comprises providing a carrier, and forming at least one consumable element on the carrier.

According to a third aspect of the present disclosure there is provided a method of making a product according to the first aspect of the present disclosure in which the method comprises
providing a carrier, and
adhering at least one preformed consumable element to the carrier.

In an embodiment of any of the above embodiments the formation of one or more of the consumable elements may be performed using known methods of consumable formation.

In an embodiment of any of the above embodiments the carrier is separated from a body of carrier material before or after forming at least one consumable element on the carrier or adhering at least one preformed consumable element to the carrier.

According to a fourth aspect of the present disclosure there is provided a kit for making a consumable for use with an apparatus for heating an aerosol generating material, in which the kit comprises at least one support and at least one product according to the first aspect of the present disclosure.

In an embodiment of the above embodiment the support of the kit is reusable.

According to a fifth aspect of the present disclosure there is provided a method of making a consumable for use with an apparatus for heating an aerosol generating material which the method comprises
(a) releasing a consumable element from a product according to the first aspect of the present disclosure, and
(b) attaching the consumable element to a support.

The attachment of the consumable element to the support can give the consumable element the rigidity and/or dimensions required to use the consumable element in connection with an apparatus for heating an aerosol generating material.

In an embodiment of the above embodiment the support of the method is reusable.

In an alternative aspect of the present disclosure there is provided a method of making a consumable for use with an apparatus for heating an aerosol generating material in which the method comprises
(a) providing a product according to the first aspect of the present disclosure, and
(b) separating a portion of the product from the remainder of the product,
in which the separated portion of the product comprises a portion of the carrier and at least one consumable element. In this method the product is so configured that the separated portion of the product, the portion of the carrier and at least one consumable element, can function as a consumable. That is the portion of the product is suitably sized and of suitable rigidity for use in the apparatus for heating the aerosol generating material without any further treatment or any other elements. In an embodiment of this embodiment the carrier is perforated to guide the tearing of the carrier/consumable units into desirably sized and shaped portions so that those portions function as consumables.

In an alternative aspect of the present invention the consumable element removed from the carrier is ready for use with an apparatus for heating an aerosol generating material without the need for any further configuration or reconfiguration. For example, the consumable element may be sufficiently rigid that it can be used in the apparatus for heating an aerosol generating material without the need for any further structural element to increase its rigidity.

In an embodiment of any of the above embodiments the aerosol-generating material comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, terpenes of non-cannabinoid origin, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

The active substance may comprise one or more constituents, derivatives or extracts of cannabis, such as one or more cannabinoids or terpenes.

In some embodiments, the active substance comprises nicotine. In some embodiments, the active substance comprises caffeine, melatonin or vitamin B12.

The active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the aerosol-generating material comprises a flavor or flavorant. As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-generating material is a material that is capable of generating aerosol, for example when heated, irradiated or energized in any other way. Aerosol-generating material may, for example, be in the form of a solid, liquid or gel which may or may not contain an active substance and/or flavorants.

The aerosol generating material comprises an aerosol former.

In some embodiments the aerosol generating agent may comprise one or more constituents capable of forming an aerosol. In some embodiments, the aerosol generating agent may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. In particular examples, the aerosol generating agent comprises glycerol.

In some embodiments, the aerosol generating agent comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

In some embodiments, the aerosol generating material may comprise from about 0.1 wt %, 0.5 wt %, 1 wt %, 3 wt %, 5 wt %, 7 wt % or 10% to about 50 wt %, 45 wt %, 40 wt %, 35 wt %, 30 wt % or 25 wt % of an aerosol generating agent (all calculated on a dry weight basis). The aerosol generating agent may act as a plasticiser. For example, the aerosol generating material may comprise 0.5-40 wt %, 3-35 wt % or 10-25 wt % of an aerosol generating agent.

In some embodiments, the aerosol generating material may comprise from about 5 wt %, 10 wt %, 20 wt %, 25 wt %, 27 wt % or 30 wt % to about 60 wt %, 55 wt %, 50 wt %, 45 wt %, 40 wt %, or 35 wt % of an aerosol generating agent (DWB). For example, the aerosol generating material may comprise 10-60 wt %, 20-50 wt %, 25-40 wt % or 30-35 wt % of an aerosol generating agent.

In some embodiments, the aerosol generating material may comprise up to about 80 wt %, such as about 40 to 80 wt %, 40 to 75 wt %, 50 to 70 wt %, or 55 to 65 wt % of an aerosol generating agent (DWB).

The aerosol generating material may also comprise a gelling agent. In some embodiments, the gelling agent comprises a hydrocolloid. In some embodiments, the gelling agent comprises one or more compounds selected from the group comprising alginates, pectins, starches (and derivatives), celluloses (and derivatives), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum guar gum, carrageenan, agarose, acacia gum, fumed silica, PDMS, sodium silicate, kaolin and polyvinyl alcohol. In some cases, the gelling agent comprises alginate and/or pectin, and may be combined with a setting agent (such as a calcium source) during formation of the aerosol generating material. In some cases, the aerosol generating material may comprise a calcium-crosslinked alginate and/or a calcium-crosslinked pectin.

In some embodiments, the gelling agent comprises one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

In some embodiments, the gelling agent comprises alginate, and the alginate is present in the aerosol generating material in an amount of from 10-30 wt % of the aerosol generating material (calculated on a dry weight basis). In some embodiments, alginate is the only gelling agent present in the aerosol generating material. In other embodiments, the gelling agent comprises alginate and at least one further gelling agent, such as pectin.

In some embodiments, the aerosol generating material comprises from about 1 wt %, 5 wt %, 10 wt %, 15 wt %, 20 wt % or 25 wt % to about 60 wt %, 50 wt %, 45 wt %, 40 wt % or 35 wt % of a gelling agent (all calculated on a dry weight basis). For example, the aerosol generating material may comprise 1-50 wt %, 5-45 wt %, 10-40 wt % or 20-35 wt % of a gelling agent.

In some embodiments, the aerosol generating material comprises from about 20 wt % 22 wt %, 24 wt % or 25 wt % to about 30 wt %, 32 wt % or 35 wt % of a gelling agent (all calculated on a dry weight basis). For example, the aerosol generating material may comprise 20-35 wt % or 25-30 wt % of a gelling agent.

In some cases, the aerosol generating material may comprise from about 1 wt %, 5 wt %, 10 wt %, 15 wt % or 20 wt % to about 60 wt %, 50 wt %, 40 wt %, 30 wt % or 25 wt % of a gelling agent (DWB). For example, the aerosol generating material may comprise 10-40 wt %, 15-30 wt % or 20-25 wt % of a gelling agent (DWB).

In examples, the aerosol generating material comprises gelling agent and filler, taken together, in an amount of from about 10 wt %, 20 wt %, 25 wt %, 30 wt %, or 35 wt % to about 60 wt %, 55 wt %, 50 wt %, or 45 wt % of the aerosol generating material. In examples, the aerosol generating material comprises gelling agent and filler, taken together, in an amount of from about 20 to 60 wt %, 25 to 55 wt %, 30 to 50 wt %, or 35 to 45 wt % of the aerosol generating material.

In examples, the aerosol generating material comprises gelling agent (i.e. without taking into account the amount of filler) in an amount of from about 5 wt %, 10 wt %, 15 wt %, 20 wt %, 25 wt %, 30 wt %, or 35 wt % to about 60 wt %, 55 wt %, 50 wt %, or 45 wt % of the aerosol generating material. In examples, the aerosol generating material comprises gelling agent (i.e. without taking into account the amount of filler) in an amount of from about 5 to 60 wt %, 20 to 60 wt %, 25 to 55 wt %, 30 to 50 wt %, or 35 to 45 wt % of the aerosol generating material.

In some examples, alginate is comprised in the gelling agent in an amount of from about 5 to 40 wt % of the aerosol generating material, or 15 to 40 wt %. That is, the aerosol generating material comprises alginate in an amount of about 5 to 40 wt % by dry weight of the aerosol generating material, or 15 to 40 wt %. In some examples, the aerosol generating material comprises alginate in an amount of from about 20 to 40 wt %, or about 15 wt % to 35 wt % of the aerosol generating material.

In some examples, pectin is comprised in the gelling agent in an amount of from about 3 to 15 wt % of the aerosol generating material. That is, the aerosol generating material comprises pectin in an amount of from about 3 to 15 wt % by dry weight of the aerosol generating material. In some examples, the aerosol generating material comprises pectin in an amount of from about 5 to 10 wt % of the aerosol generating material.

In some examples, guar gum is comprised in the gelling agent in an amount of from about 3 to 40 wt % of the aerosol generating material. That is, the aerosol generating material comprises guar gum in an amount of from about 3 to 40 wt % by dry weight of the aerosol generating material. In some examples, the aerosol generating material comprises guar gum in an amount of from about 5 to 10 wt % of the aerosol generating material. In some examples, the aerosol generating material comprises guar gum in an amount of from about 15 to 40 wt % of the aerosol generating material, or from about 20 to 40 wt %, or from about 15 to 35 wt %.

In examples, the alginate is present in an amount of at least about 50 wt % of the gelling agent. In examples, the aerosol generating material comprises alginate and pectin, and the ratio of the alginate to the pectin is from 1:1 to 10:1. The ratio of the alginate to the pectin is typically >1:1, i.e. the alginate is present in an amount greater than the amount of pectin. In examples, the ratio of alginate to pectin is from about 2:1 to 8:1, or about 3:1 to 6:1, or is approximately 4:1.

The aerosol generating material may be formed by (a) forming a slurry comprising components of the aerosol generating material or precursors thereof, (b) forming a layer of the slurry, (c) setting the slurry to form a gel, and (d) drying to form an aerosol generating material.

The (b) forming a layer of the slurry typically comprises spraying, casting or extruding the slurry. In examples, the slurry layer is formed by electrospraying the slurry. In examples, the slurry layer is formed by casting the slurry.

In some examples, (b) and/or (c) and/or (d), at least partially, occur simultaneously (for example, during electrospraying). In some examples, (b), (c) and (d) occur sequentially.

In some examples, the slurry is applied to a support. The layer may be formed on a support.

In examples, the slurry comprises gelling agent, aerosol-former material and active substance. The slurry may comprise these components in any of the proportions given herein in relation to the composition of the aerosol generating material. For example, the slurry may comprise (on a dry weight basis):
gelling agent and, optionally, filler, wherein the amount of gelling agent and filler taken together is about 10 to 60 wt % of the slurry;
aerosol-former material in an amount of about 40 to 80 wt % of the slurry; and
optionally, active substance in an amount of up to about 20 wt % of the slurry.

The setting the gel (c) may comprise supplying a setting agent to the slurry. For example, the slurry may comprise sodium, potassium or ammonium alginate as a gel-precursor, and a setting agent comprising a calcium source (such as calcium chloride), may be added to the slurry to form a calcium alginate gel.

In examples, the setting agent comprises or consists of calcium acetate, calcium formate, calcium carbonate, calcium hydrogencarbonate, calcium chloride, calcium lactate, or a combination thereof. In some examples, the setting agent comprises or consists of calcium formate and/or calcium lactate. In particular examples, the setting agent comprises or consists of calcium formate. The inventors have identified that, typically, employing calcium formate as a setting agent results in an aerosol generating material having a greater tensile strength and greater resistance to elongation.

The total amount of the setting agent, such as a calcium source, may be 0.5-5 wt % (calculated on a dry weight basis). Suitably, the total amount may be from about 1 wt %, 2.5 wt % or 4 wt % to about 4.8 wt % or 4.5 wt %. The inventors have found that the addition of too little setting agent may result in an aerosol generating material which does not stabilise the aerosol generating material components and results in these components dropping out of the aerosol generating material. The inventors have found that the addition of too much setting agent results in an aerosol generating material that is very tacky and consequently has poor handleability.

When the aerosol generating material does not contain tobacco, a higher amount of setting agent may need to be applied. In some cases the total amount of setting agent may therefore be from 0.5-12 wt % such as 5-10 wt %, calculated on a dry weight basis. Suitably, the total amount may be from about 5 wt %, 6 wt % or 7 wt % to about 12 wt % or 10 wt %. In this case the aerosol generating material will not generally contain any tobacco.

In examples, supplying the setting agent to the slurry comprises spraying the setting agent on the slurry, such as a top surface of the slurry.

Alginate salts are derivatives of alginic acid and are typically high molecular weight polymers (10-600 kDa). Alginic acid is a copolymer of P-D-mannuronic (M) and a-L-guluronic acid (G) units (blocks) linked together with (1,4)-glycosidic bonds to form a polysaccharide. On addition of calcium cations, the alginate crosslinks to form a gel. It has been found that alginate salts with a high G monomer content more readily form a gel on addition of the calcium source. In some cases therefore, the gel-precursor may comprise an alginate salt in which at least about 40%, 45%, 50%, 55%, 60% or 70% of the monomer units in the alginate copolymer are a-L-guluronic acid (G) units.

In examples, the drying (d) removes from about 50 wt %, 60 wt %, 70 wt %, 80 wt % or 90 wt % to about 80 wt %, 90 wt % or 95 wt % (WWB) of water in the slurry.

In examples, the drying (d) reduces the cast material thickness by at least 80%, suitably 85% or 87%. For instance, the slurry is cast at a thickness of 2 mm, and the resulting dried aerosol generating material has a thickness of 0.2 mm.

In some examples, the slurry solvent consists essentially of or consists of water. In some examples, the slurry comprises from about 50 wt %, 60 wt %, 70 wt %, 80 wt % or 90 wt % of solvent (WWB).

In examples where the solvent consists of water, the dry weight content of the slurry may match the dry weight content of the aerosol generating material. Thus, the discussion herein relating to the solid composition is explicitly disclosed in combination with the slurry aspect of the invention.

The aerosol generating material may comprises a flavor. Suitably, the aerosol generating material may comprise up to about 80 wt %, 70 wt %, 60 wt %, 55 wt %, 50 wt % or 45 wt % of a flavor. In some cases, the aerosol generating material may comprise at least about 0.1 wt %, 1 wt %, 10 wt %, 20 wt %, 30 wt %, 35 wt % or 40 wt % of a flavor (all calculated on a dry weight basis). For example, the aerosol generating material may comprise 1-80 wt %, 10-80 wt %, 20-70 wt %, 30-60 wt %, 35-55 wt % or 30-45 wt % of a flavor. In some cases, the flavor comprises, consists essentially of or consists of menthol.

The aerosol generating material may comprises a filler.

In some embodiments, the aerosol generating material comprises less than 60 wt % of a filler, such as from 1 wt % to 60 wt %, or 5 wt % to 50 wt %, or 5 wt % to 30 wt %, or 10 wt % to 20 wt %.

In other embodiments, the aerosol generating material comprises less than 20 wt %, suitably less than 10 wt % or less than 5 wt % of a filler. In some cases, the aerosol generating material comprises less than 1 wt % of a filler, and in some cases, comprises no filler.

In some such cases the aerosol generating material comprises at least 1 wt % of the filler, for example, at least 5 wt %, at least 10 wt %, at least 20 wt % at least 30 wt %, at least 40 wt %, or at least 50 wt % of the filler. In some embodiments, the aerosol generating material comprises 5-25 wt % of the filler.

The filler, if present, may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives (such as methylcellulose, hydroxypropyl cellulose, and carboxymethyl cellulose (CMC)). In particular cases, the aerosol generating material comprises no calcium carbonate such as chalk.

In particular embodiments which include filler, the filler is fibrous. For example, the filler may be a fibrous organic filler material such as wood pulp, hemp fiber, cellulose or cellulose derivatives (such as methylcellulose, hydroxypropyl cellulose, and carboxymethyl cellulose (CMC)).

Without wishing to be bound by theory, it is believed that including fibrous filler in an aerosol generating material may increase the tensile strength of the material. This may be particularly advantageous in examples wherein the aerosol generating material is provided as a sheet, such as when an aerosol generating material sheet circumscribes a rod of aerosolizable material.

In some embodiments, the aerosol generating material does not comprise tobacco fibers. In particular embodiments, the aerosol generating material does not comprise fibrous material.

The aerosol-generating material may comprise one or more active substances and/or flavors, one or more aerosol-former materials, and optionally one or more other functional material.

In some embodiments, the aerosol generating material additionally comprises an active substance. For example, in some cases, the aerosol generating material additionally comprises a tobacco material and/or nicotine. In some embodiments, the aerosol generating material comprises powdered tobacco and/or nicotine and/or a tobacco extract.

In some cases, the aerosol generating material may comprise 5-60 wt % (calculated on a dry weight basis) of a tobacco material and/or nicotine. In some cases, the aerosol generating material may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of an active substance. In some cases, the aerosol generating material may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of a tobacco material. For example, the aerosol generating material may comprise 10-50 wt %, 15-40 wt % or 20-35 wt % of a tobacco material. In some cases, the aerosol generating material may comprise from about 1 wt %, 2 wt %, 3 wt % or 4 wt % to about 20 wt %, 18 wt %, 15 wt % or 12 wt % (calculated on a dry weight basis) of nicotine. For example, the aerosol generating material may comprise 1-20 wt %, 2-18 wt % or 3-12 wt % of nicotine.

In some cases, the aerosol generating material comprises an active substance such as tobacco extract. In some cases, the aerosol generating material may comprise 5-60 wt % (calculated on a dry weight basis) of tobacco extract. In some cases, the aerosol generating material may comprise from about 5 wt %, 10 wt %, 15 wt %, 20 wt % or 25 wt % to about 60 wt %, 50 wt %, 45 wt %, 40 wt %, 35 wt %, or 30 wt % (calculated on a dry weight basis) tobacco extract. For example, the aerosol generating material may comprise 10-50 wt %, 15-40 wt % or 20-35 wt % of tobacco extract. The tobacco extract may contain nicotine at a concentration such that the aerosol generating material comprises 1 wt % 1.5 wt %, 2 wt % or 2.5 wt % to about 6 wt %, 5 wt %, 4.5 wt % or 4 wt % (calculated on a dry weight basis) of nicotine. In some cases, there may be no nicotine in the aerosol generating material other than that which results from the tobacco extract.

In some embodiments the aerosol generating material comprises no tobacco material but does comprise nicotine. In some such cases, the aerosol generating material may comprise from about 1 wt %, 2 wt %, 3 wt % or 4 wt % to about 20 wt %, 18 wt %, 15 wt % or 12 wt % (calculated on a dry weight basis) of nicotine. For example, the aerosol generating material may comprise 1-20 wt %, 2-18 wt % or 3-12 wt % of nicotine.

In some cases, the total content of active substance and/or flavor may be at least about 0.1 wt %, 1 wt %, 5 wt %, 10 wt %, 20 wt %, 25 wt % or 30 wt %. In some cases, the total content of active substance and/or flavor may be less than about 90 wt %, 80 wt %, 70 wt %, 60 wt %, 50 wt % or 40 wt % (all calculated on a dry weight basis).

In some cases, the total content of tobacco material, nicotine and flavor may be at least about 0.1 wt %, 1 wt %, 5 wt %, 10 wt %, 20 wt %, 25 wt % or 30 wt %. In some cases, the total content of active substance and/or flavor may be less than about 90 wt %, 80 wt %, 70 wt %, 60 wt %, 50 wt % or 40 wt % (all calculated on a dry weight basis).

The aerosol-generating composition may comprise one or more active substances. In examples, the aerosol generating material comprises one or more active substances, e.g. up to about 20 wt % of the aerosol generating material. In examples, the aerosol generating material comprises active substance in an amount of from about 1 wt %, 5 wt %, 10 wt %, or 15 wt % to about 20 wt %, 15 wt %, 15 wt % or 5 wt % of the aerosol generating material.

The active substance may comprise a physiologically and/or olfactory active substance which is included in the aerosol-generating composition in order to achieve a physiological and/or olfactory response.

Tobacco material may be present in the aerosol-generating composition in an amount of from about 50 to 95 wt %, or about 60 to 90 wt %, or about 70 to 90 wt %, or about 75 to 85 wt %.

The tobacco material may be present in any format, but is typically fine-cut (e.g. cut into narrow shreds). Fine-cut tobacco material may advantageously be blended with the aerosol generating material to provide an aerosol-generating composition which has an even dispersion of tobacco material and aerosol generating material throughout the aerosol-generating composition.

In examples, the tobacco material comprises one or more of ground tobacco, tobacco fiber, cut tobacco, extruded tobacco, tobacco stem, reconstituted tobacco and/or tobacco extract. Surprisingly, the inventors have identified that it is possible to use a relatively large amount of lamina tobacco in the aerosol-generating composition and still provide an acceptable aerosol when heated by a non-combustible aerosol provision system. Lamina tobacco typically provides superior sensory characteristics. In examples, the tobacco material comprises lamina tobacco in an amount of at least about 50 wt %, 60 wt %, 70 wt %, 80 wt %, 85 wt %, 90 wt %, or 95 wt % of the tobacco material. In particular examples, the tobacco material comprises cut tobacco in an amount of at least about 50 wt %, 60 wt %, 70 wt %, 80 wt %, 85 wt %, 90 wt %, or 95 wt % of the tobacco material.

The tobacco used to produce tobacco material may be any suitable tobacco, such as single grades or blends, cut rag or whole leaf, including Virginia and/or Burley and/or Oriental.

In some embodiments the one or more other functional materials may comprise one or more of pH regulators, coloring agents, preservatives, binders, fillers, stabilizers, and/or antioxidants.

In some cases, the aerosol generating material may additionally comprise an emulsifying agent, which emulsified molten flavor during manufacture. For example, the aerosol generating material may comprise from about 5 wt % to about 15 wt % of an emulsifying agent (calculated on a dry weight basis), suitably about 10 wt %. The emulsifying agent may comprise acacia gum.

In some embodiments, the aerosol generating material is a hydrogel and comprises less than about 20 wt % of water calculated on a wet weight basis. In some cases, the hydrogel may comprise less than about 15 wt %, 12 wt % or 10 wt % of water calculated on a wet weight basis. In some cases, the hydrogel may comprise at least about 1 wt %, 2 wt % or at least about 5 wt % of water (WWB).

The aerosol generating material may have any suitable water content, such as from 1 wt % to 15 wt %. Suitably, the water content of the aerosol generating material is from about 5 wt %, 7 wt % or 9 wt % to about 15 wt %, 13 wt % or 11 wt % (WWB), most suitably about 10 wt %. The water content of the aerosol generating material may, for example, be determined by Karl-Fischer-titration or Gas Chromatography with Thermal Conductivity Detector (GC-TCD).

In some cases, the aerosol generating material may consist essentially of, or consist of a gelling agent, water, an aerosol generating agent, a flavor, and optionally an active substance.

In some cases, the aerosol generating material may consist essentially of, or consist of a gelling agent, water, an aerosol generating agent, a flavor, and optionally a tobacco material and/or a nicotine source.

In examples, the aerosol generating material consists essentially of, or consists of a gelling agent, aerosol generating agent, active substance, and water. In examples, the aerosol generating material consists essentially of, or consists of a gelling agent, aerosol generating agent, and water.

In examples, the aerosol generating material does not comprise a flavorant; in particular examples, the aerosol generating material does not comprise an active substance.

In some embodiments the aerosol generating material comprises:
1-60 wt % of a gelling agent;
0.1-50 wt % of an aerosol generating agent; and
0.1-80 wt % of a flavor;

wherein these weights are calculated on a dry weight basis

In some embodiments, the aerosol generating material comprises 1-80 wt % of a flavor (dry weight basis).

In some embodiments, the aerosol generating material comprising:
1-50 wt % of a gelling agent;
0.1-50 wt % of an aerosol generating agent; and
30-60 wt % of a flavor;

wherein these weights are calculated on a dry weight basis.

In alternative embodiments of the aerosol generating material, the aerosol generating material comprises:
1-60 wt % of a gelling agent;
5-60 wt % of an aerosol generating agent; and
10-60 wt % of a tobacco extract;

wherein these weights are calculated on a dry weight basis.

In some embodiments, the aerosol generating material comprises:
1-60 wt % of a gelling agent;
20-60 wt % of an aerosol generating agent; and
10-60 wt % of a tobacco extract;

wherein these weights are calculated on a dry weight basis.

In some embodiments, the aerosol generating material comprises 20-35 wt % of the gelling agent; 10-25 wt % of the aerosol-former material; 5-25 wt % of the filler comprising fibers; and 35-50 wt % of the flavorant and/or active substance.

In some cases, the aerosol generating material may consist essentially of, or consist of a gelling agent, an aerosol generating agent a tobacco extract, water, and optionally a flavor. In some cases, the aerosol generating material may consist essentially of, or consist of glycerol, alginates and/or pectins, a tobacco extract and water.

In some embodiments, the aerosol generating material may have the following composition (DWB): gelling agent (preferably comprising alginate) in an amount of from about 5 wt % to about 40 wt %, or about 10 wt % to 30 wt %, or about 15 wt % to about 25 wt %; tobacco extract in an amount of from about 30 wt % to about 60 wt %, or from about 40 wt % to 55 wt %, or from about 45 wt % to about 50 wt %; aerosol generating agent (preferably comprising glycerol) in an amount of from about 10 wt % to about 50 wt %, or from about 20 wt % to about 40 wt %, or from about 25 wt % to about 35 wt % (DWB).

In one embodiment, the aerosol generating material comprises about 20 wt % alginate gelling agent, about 48 wt % Virginia tobacco extract and about 32 wt % glycerol (DWB). The “thickness” of the aerosol generating material describes the shortest distance between a first surface and a second surface. In embodiments where the aerosol generating material is in the form of a sheet, the thickness of the aerosol generating material is the shortest distance between a first planar surface of the sheet and a second planar surface of the sheet which opposes the first planar surface of the sheet.

In some cases, the aerosol-forming aerosol generating material layer has a thickness of about 0.015 mm to about 1.5 mm, suitably about 0.05 mm to about 1.5 mm or 0.05 mm to about 1.0 mm. Suitably, the thickness may be in the range of from about 0.1 mm or 0.15 mm to about 1.0 mm, 0.5 mm or 0.3 mm.

In some cases, the aerosol generating material may have a thickness of about 0.015 mm to about 1.0 mm. Suitably, the thickness may be in the range of about 0.05 mm, 0.1 mm or 0.15 mm to about 0.5 mm or 0.3 mm.

A material having a thickness of 0.2 mm is particularly suitable. The aerosol generating material may comprise more than one layer, and the thickness described herein refers to the aggregate thickness of those layers.

It has been that if the aerosol-generating material or aerosol generating material is too thick, then heating efficiency is compromised. This adversely affects the power consumption in use. Conversely, if the aerosol-generating material or aerosol generating material is too thin, it is difficult to manufacture and handle; a very thin material is harder to cast and may be fragile, compromising aerosol formation in use.

The thickness stipulated herein is a mean thickness for the material. In some cases, the aerosol generating material thickness may vary by no more than 25%, 20%, 15%, 10%, 5% or 1%.

In some examples, the aerosol generating material in sheet form may have a tensile strength of from around 200 N/m to around 900 N/m. In some examples, such as where the aerosol generating material does not comprise a filler, the aerosol generating material may have a tensile strength of from 200 N/m to 400 N/m, or 200 N/m to 300 N/m, or about 250 N/m.

Such tensile strengths may be particularly suitable for embodiments wherein the aerosol generating material is formed as a sheet and then shredded and incorporated into an aerosol generating article. In some examples, such as where the aerosol generating material comprises a filler, the aerosol generating material may have a tensile strength of from 600 N/m to 900 N/m, or from 700 N/m to 900 N/m, or around 800 N/m. Such tensile strengths may be particularly suitable for embodiments wherein the aerosol generating material is included in an aerosol generating article/assembly as a rolled sheet, suitably in the form of a tube.

In some examples, the aerosol generating material in sheet form may have a tensile strength of from around 200 N/m to around 2600 N/m. In some examples, the aerosol generating material may have a tensile strength of from 600 N/m to 2000 N/m, or from 700 N/m to 1500 N/m, or around 1000 N/m. Such tensile strengths may be particularly suitable for embodiments wherein the aerosol-generating material comprising the aerosol generating material is formed and incorporated into an aerosol-generating consumable as a sheet.

The aerosol generating material comprising the aerosol generating material may have any suitable area density, such as from 30 g/m² to 120 g/m². In some cases, the sheet may have a mass per unit area of 80-120 g/m², or from about 70 to 110 g/m², or particularly from about 90 to 110 g/m², or suitably about 100 g/m² (so that it has a similar density to cut rag tobacco and a mixture of these substances will not readily separate). In some cases, the sheet may have a mass per unit area of about 30 to 70 g/m², 40 to 60 g/m², or 25-60 g/m² and may be used to wrap an aerosolizable material such as tobacco.

All percentages by weight described herein (denoted wt %) are calculated on a dry weight basis, unless explicitly stated otherwise. All weight ratios are also calculated on a dry weight basis. A weight quoted on a dry weight basis refers to the whole of the extract or slurry or material, other than the water, and may include components which by themselves are liquid at room temperature and pressure, such as glycerol. Conversely, a weight percentage quoted on a wet weight basis refers to all components, including water.

The aerosol generating material may comprise a colorant. The addition of a colorant may alter the visual appearance of the aerosol generating material. The presence of colorant in the aerosol generating material may enhance the visual appearance of the aerosol generating material and the aerosol-generating material. By adding a colorant to the aerosol generating material, the aerosol generating material may be color-matched to other components of the aerosol-generating material or to other components of an article comprising the aerosol generating material.

A variety of colorants may be used depending on the desired color of the aerosol generating material. The color of aerosol generating material may be, for example, white, green, red, purple, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the aerosol generating material with a brown appearance. In such embodiments, the color of the aerosol generating material may be similar to the color of other components (such as tobacco material) in an aerosol-generating material comprising the aerosol generating material. In some embodiments, the addition of a colorant to the aerosol generating material renders it visually indistinguishable from other components in the aerosol-generating material.

The colorant may be incorporated during the formation of the aerosol generating material (e.g. when forming a slurry comprising the materials that form the aerosol generating material) or it may be applied to the aerosol generating material after its formation (e.g. by spraying it onto the aerosol generating material).

In some embodiments of any of the above embodiments, talcum powder, calcium carbonate powder or other powder is applied to the exposed surface of at least one discrete portion of aerosol-generating material. This may reduce the level of tackiness or adhesion of the aerosol-generating material.

In the following discussions of the accompanying drawings, where the same element is present in a more than one embodiment the same reference numeral is used for that element throughout, where there are similar elements similar reference numerals (the same numeral plus a multiple of 100) are used.

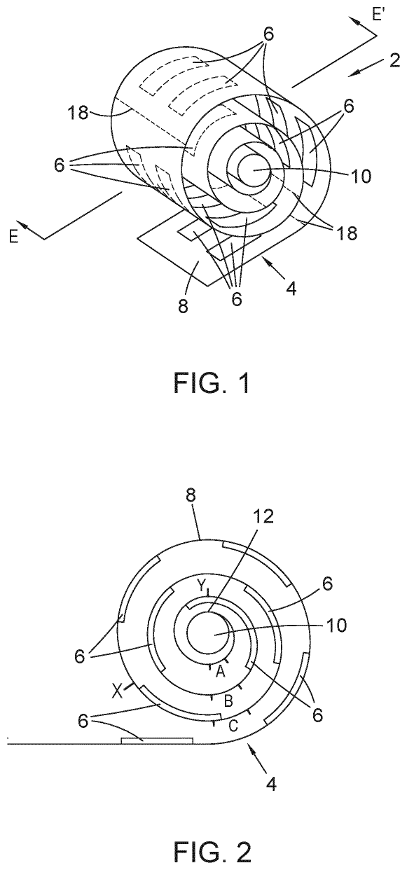

With reference to FIGS. 1 and 2, a product 2 comprises a carrier 8 and a plurality of consumable elements 6. The product 2 in FIG. 1 is in a packed configuration which, in this example of the present disclosure, is a loose coil. The coil is described as loose because although layers of the carrier 8 overlie each other, there is a space between the overlying layers. The coil is centred on a bobbin 10 with an end 12 of the carrier 8 being anchored onto the bobbin by an adhesive (not shown).

The carrier 8 is a longitudinally extending, parallel sided, sheet or ribbon of a thin card. The card is sufficiently thin to be able to be curved into a coil without damage to the card. Along the length of the portion of the carrier 8 approximately between markers X and Y in FIG. 2 each part of the carrier 8 both overlies the portion of the carrier 8 that is radially inward of that part and is overlaid by the portion of the carrier 8 that is radially outward of that part. For example, for portion B as shown in FIG. 2, portion B overlies portion A and is overlaid by portion C.

The plurality of consumable elements 6 are applied to the radially inner surface of the carrier 8 when it is configured as a coil. The consumable elements 6 are applied to the card in pairs which are located side by side in a direction perpendicular to the longitudinal axis of the carrier 8. The pairs of consumable elements 6 are evenly spaced on the carrier 8 in the longitudinal direction.

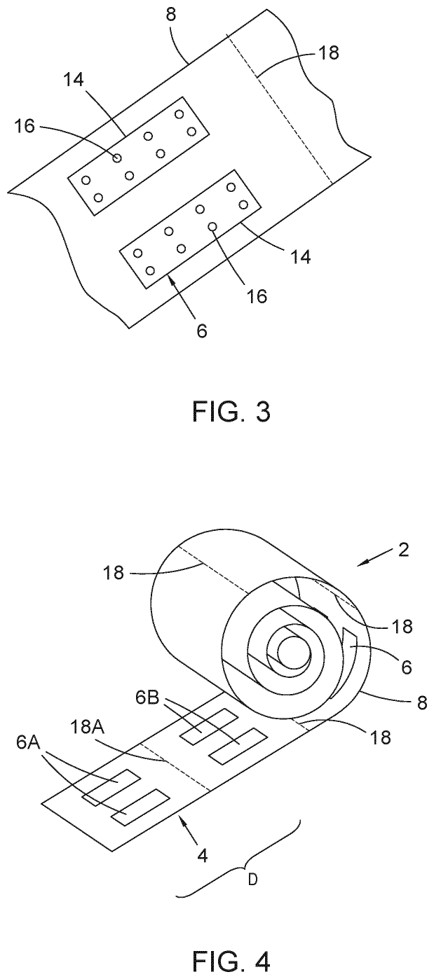

With reference to FIG. 3, each consumable element 6 includes a support 14 and a plurality of dots of aerosol generating film 16 (for clarity, only two of the dots of aerosol generating film 16 are labelled). In the example of the consumable element 6 illustrated in FIG. 3, the dots of aerosol generating film 16 are located on the face of the support 14 that faces away from the portion of carrier 8 to which the consumable element 6 is applied. Alternatively expressed, the support 14 is between the carrier 8 and the dots of aerosol generating film 16. In other, non-illustrated examples, the dots of aerosol generating film 16 are located between the carrier 8 and the support 14. In the illustrated example, the support 14 is formed from a metallic foil, for example aluminium foil. This allows the support 14 to act as a susceptor if the dots of aerosol generating film 16 are to be heated by an inductive heating technique.

Each consumable element 6 is attached to the carrier 8 by a pressure adhesive (not shown) which allows the consumable elements 6 to be adhered to the carrier 8 by pushing the consumable element 6 onto the surface of the carrier 8, and the consumable elements 6 to be subsequently peeled off the carrier 8.

The carrier 8 includes a plurality of lines of perforations 18. Each line of perforations 18 extends in a direction approximately perpendicular to the longitudinal axis of the carrier 8 and between longitudinally adjacent pairs of consumable elements 6. The perforations are such that the carrier 8 may be torn along the line of the perforations 18.

With reference to FIG. 4, FIG. 4 shows the product 2 when a portion D of the carrier 8 is in a dispensing configuration. In this configuration portion D is not overlain by an overlying portion of carrier 8 and does not overlie an overlain portion of carrier 8. This allows a user to access and remove the consumable elements 6A from the carrier 8 without obstruction from another portion of the carrier 8.

Once the consumable elements 6A have been removed from the carrier 8, the user can, should they so wish, tear the carrier 8 along the line of perforations 18A to remove the portion of the carrier 8 that no longer supports consumable elements 6. when the user wishes to remove more consumable elements 6 from the product 2, unwinding the coil of carrier 8 will move the part of the carrier 8 to which consumable elements 6B are applied into the dispensing configuration. The consumable elements 6B can then be removed. This process can be repeated until all of the consumable elements 6 have been removed from the carrier 8.

In an alternative use of the product 2, the user can tear a portion of the dispensing material off the coil along a perforation line 18 before the consumable elements 6A are removed from the carrier 8. The consumable elements 6A may subsequently be removed from the carrier 8 but this could occur a period of time later, possibly minutes, hours, days or weeks later.

The consumable elements 6A are comprised of an aluminium foil support and an aerosol generating material film that covers the whole of one major surface of the support. The other major surface of the support is adapted to attach to the carrier 4.

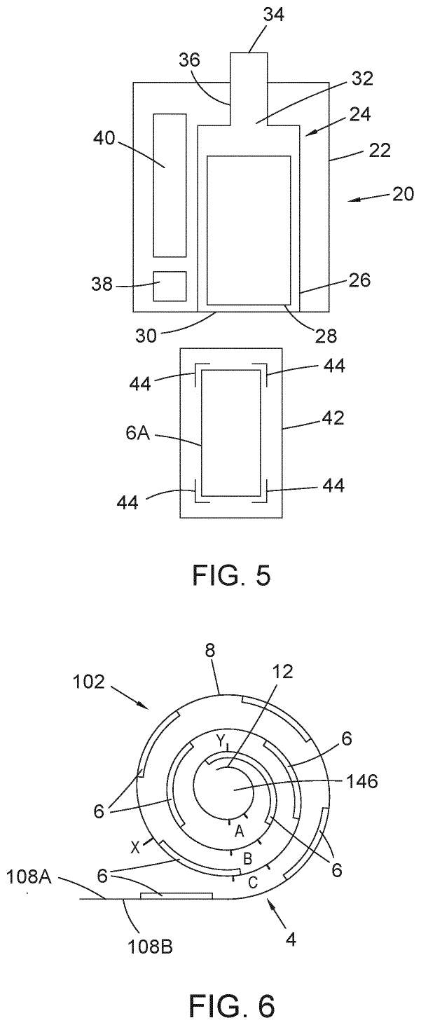

With reference to FIG. 5, once a consumable element 6A has been removed from carrier 8, it may be used in connection with an aerosol provision device 20. The aerosol provision device 20 comprises a casing 22 within which is located a heater assembly 24. The heater assembly 24 is comprised of a heating chamber 26 and a heater 28. The heater 28 can be an electrical resistance heater or a magnetic field generator for use with a susceptor.

The heating chamber 26 defines an opening or mouth 30 at a first end of the heating chamber 26. At the opposite end of the heating chamber 26 is an aperture 32. The aperture 32 is in fluid communication with a mouth piece 34 via a conduit 36.

Also located within the casing 22 is a controller 38 which is in electronic communication with and controls the functioning of the heater 26. The controller 38 may include a memory (not shown) within which one or more tables relating to the operation of the heater 28 may be stored. The heater 28 and controller 38 are powered by a power source 40. The power source 40 is a rechargeable battery. In other embodiments the power source may be other appropriate sources of electrical power.

The aerosol provision device 20 is suitable for use with a support 42 to which a consumable element 6A is attached. The support 42 includes alignment marks 44 which allows the user to correctly locate the consumable element 6A on the support 42. The attachment of the consumable element 6A to the support 42 is achieved using a pressure adhesive (not shown).

The support 42 is then placed within the heating chamber 26 and the dots of aerosol generating film 16 caused to aerosolize.

Once all the dots of aerosol generating film 16 of the consumable element 6A have been aerosolized, the support 42 is removed from the heating chamber 26. The consumable element 6A is removed from the support 42 and replaced by a fresh consumable element 6.

With reference to FIG. 6, a product 102 is illustrated. Product 102 is very similar to product 2, with the following differences.

The carrier 108 has a first surface 108A and a second surface 108B. The consumable elements 6 are attached to the first surface 108A by a pressure adhesive (not shown). The second surface 108B is treated so that the surface 108B is not capable of forming an adhesive bond with a consumable element 6 or dots of aerosol generating film 16 that is as strong as the adhesive bond between the consumable element 6 and the first surface 108A, or the dots of aerosol generating film 16 and the support 14.

The first surface 108A of the carrier 108 is bonded to a surface of the consumable element 6 using a releasable adhesive (not shown). The relative characteristics of the first surface 108A and the surface of the consumable element 6 are chosen or caused to be such that when the consumable element 6 is removed from the first surface 108A of the carrier 108 the adhesive remains on the first surface 108A of the carrier.

The coil of carrier 108 is not wound around the bobbin 10. In product 102, the coil of carrier 108 is wound around a void 146.

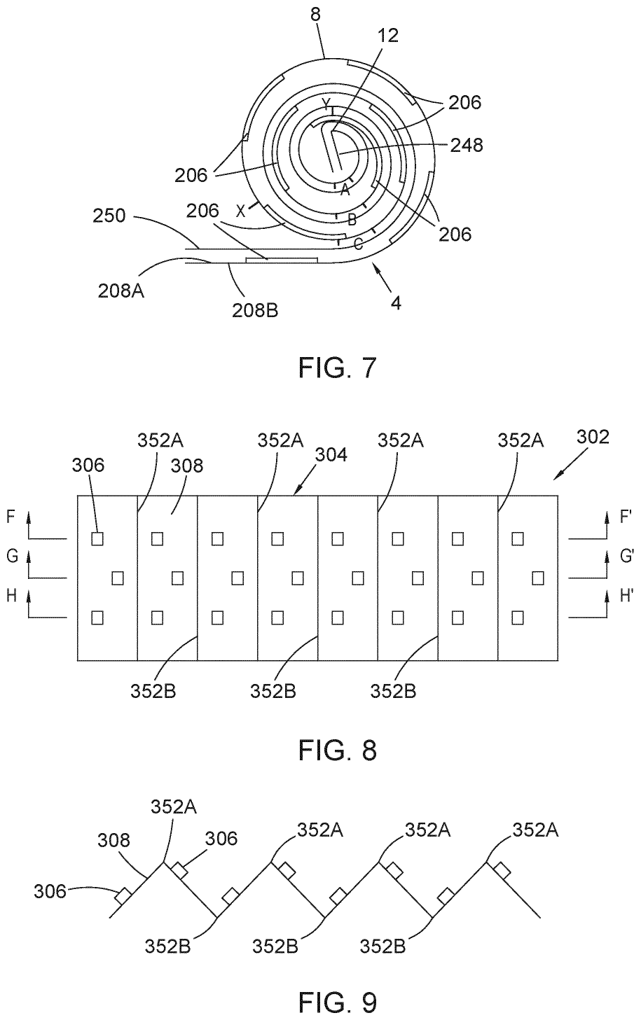

With reference to FIG. 7, a product 202 is illustrated. Product 202 is very similar to product 2, with the following differences.

The coil of carrier 208 is not wound around the bobbin 10. In product 202, the coil of carrier 208 is wound around a folded over end 248 of the carrier 208. The carrier 208 has a first surface 208A and a second surface 208B. The consumable elements 206 are attached to the first surface 208A by a pressure adhesive (not shown).

A sheet of barrier material 250 was laid over the surface of the carrier 208 on which a plurality of consumable elements 206 are attached prior to the product 202 being configured into the packed configuration. This has the effect that when the carrier 208 is configured as a coil the barrier material 250 is between the consumable elements 206 and the second surface 208B of the carrier. This prevents the consumable elements 206 adhering to the second surface 208B of the carrier 208.

In the consumable elements 206, at least one dot of aerosol generating film 16 is of a different composition to at least one other dot of aerosol generating film 16.

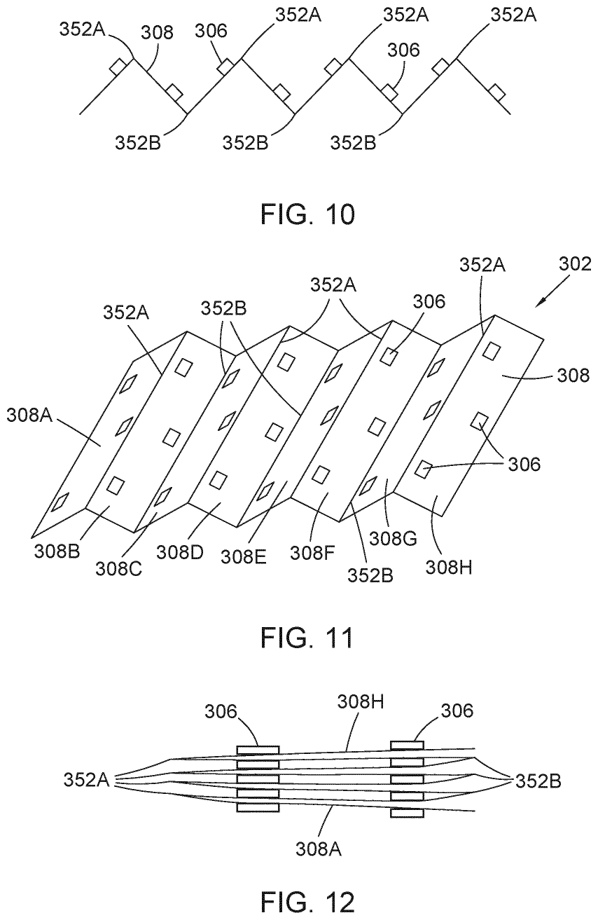

With reference to FIGS. 8 to 11, a product 302 comprises a carrier 308 and a plurality of consumable elements 306. The carrier 308 in FIGS. 8 to 11 is in the process of being folded into a packed configuration in the form of a concertina which is shown (in side view) in FIG. 12.

The carrier 308 is a longitudinally extending, parallel sided, sheet or ribbon of a thin card. The card is sufficiently thin to be able to be folded into a packed configuration in the form of a concertina around fold lines 352A, 352B without damage to the card. The carrier 308 is divided into eight panels 308A to 308H (for clarity the panels are only fully labelled in FIG. 11) with each panel being defined by one or two fold lines 308A, 308B and one or more edges of the carrier 308.

When the product 302 is in the packed configuration, each of panels 308B to 308G both overlies an adjacent panel and is overlaid by an adjacent panel. For example, panel 308B overlies panel 308A and is overlaid by panel 308C.

The plurality of consumable elements 306 are all applied to one of the major surfaces of the carrier 308. There are three consumable elements 306 applied to each panel and, on each panel, the consumable elements 306 are applied in the same arrangement and at the same relative positions on the surface of each panel. The arrangement is such that when the carrier 308 is folded into the packed configuration the consumable elements 306 on the panels on either side of a fold line 352B do not contact each other. In the example illustrated in FIGS. 8 to 11 that arrangement is in the form of an isosceles triangle with the base of the triangle being approximately parallel to the left hand edge of each panel 308A to 308H as seen in FIG. 8. Other arrangements fall within the scope of the present disclosure.

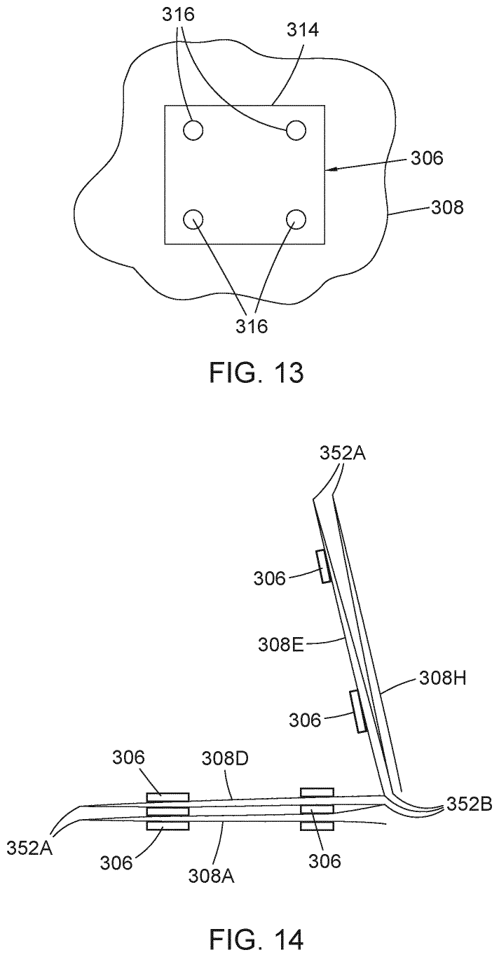

With reference to FIG. 13, each consumable element 306 includes a support 314 and a plurality of dots of aerosol generating film 316. In the example of the consumable element 306 illustrated in FIG. 13, the dots of aerosol generating film 316 are located on the face of the support 314 that faces away from the portion of carrier 308 to which the consumable element 306 is applied. Alternatively expressed, the support 314 is between the carrier 308 and the dots of aerosol generating film 316. In the illustrated example the support 314 is formed from a metallic foil, for example aluminium foil. This allows the support to act as a susceptor if the dots of aerosol generating film 316 are to be heated by an inductive heating technique.

Each consumable element 306 is attached to the carrier 308 by a pressure adhesive (not shown) which allows the consumable elements 306 to be adhered to the carrier 308 by pushing the consumable element 306 onto the surface of the carrier 308, and the consumable elements 306 to be subsequently peeled off the carrier 308.

With reference to FIG. 14, FIG. 14 shows the product 302 when panels 308D and 308E of the dispenser material 304 are in a dispensing configuration. In this configuration the faces of the panels 308D and 308E to which the consumable elements 306 are applied are not overlain by an overlying panel of the carrier 308. This allows a user to access and remove the consumable elements 306 from the panels 308D and 308E of carrier 308 without obstruction from a portion of dispenser material 304.

Once the consumable elements 306 have been removed from the carrier 308, the user can use them in the same fashion as discussed in connection with product 6 above. The product can then be reconfigured back into the packed configuration as shown in FIG. 12.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A product for storing and dispensing two or more consumable elements for use with a non-combustible aerosol provision system, in which
the product comprises two or more consumable elements and a carrier,
the consumable elements are supported on the carrier,
the product is reversibly configurable between a packed configuration and one or more dispensing configurations,
the packed configuration is one in which the consumable elements cannot be removed from the product,
a dispensing configuration is a configuration in which a consumable element may be removed from the product.

2. A product according to claim 1 in which the carrier is formed of a sheet material.

3. A product according to claim 1 in which the carrier is a longitudinally extending strip of material.

4. A product according to claim 1 in which the carrier is a material which is capable of bending without breaking.

5. A product according to claim in which the carrier comprises at least one of paper, card, plastics or metallic foil.

6. A product according to claim 1 in which at least a portion of the carrier both overlies an overlain portion of the carrier and is overlaid by an overlying portion of the carrier when the product is in the packed configuration.

7. A product according to claim 1 in which the packed configuration of the product comprises the carrier wound around an inner support, in which the carrier is wound around the inner support at least twice, or at least three times.

8. A product according to claim 1 in which the packed configuration of the product comprises the carrier wound around a void, in which the carrier is wound around the void at least twice, or at least three times.

9. A product according to claim 1 in which the packed configuration of the product comprises the carrier wound around an end portion of the carrier, in which the carrier is wound around the end portion at least twice, or at least three times.

10. A product according to claim 7 in which the winding of the carrier is in the form of a spiral or coil.

11. A product according to claim 1 in which the packed configuration of the product comprises two or more fold lines in the carrier and a panel between each adjacent pair of fold lines, and the carrier is folded into a concertina configuration.

12. A product according to claim 1 in which the consumable elements cannot be removed from the product because the carrier prevents a user being able to access to the consumable elements.

13. A product according to claim 12 in which the carrier overlies the consumable elements.

14. A product according to claim 1 in which a dispensing configuration of the product is a configuration in which a portion of the carrier which supports at least one consumable element is one or both of not overlain by an overlying portion of carrier and does not overlie an overlain portion of carrier.

15. A product according to claim 1 in which the product further comprises a barrier material, and the barrier material is located between overlying portions of the carrier when those portions are in the packed configuration.

16. A product according to claim 1 in which the product comprises at least one set of perforations, the perforations extend through at least the carrier, and the perforations of at least one set are so arranged that the perforations form a line along which the carrier may be torn.

17. A product according to claim 16 in which the perforations of at least one set of perforations are so configured that tearing of the carrier along the set of perforations separates a portion of the carrier from the remaining carrier.

18. A product according to claim 16 in which the perforations of at least one set of perforations are so configured that tearing of the carrier along the set of perforations separates a portion of carrier which supports at least one consumable element from the rest of the carrier.

19. A product according to claim 1 in which at least one consumable element comprises at least one discrete portion of aerosol generating material.

20. A product according to claim 19 in which the aerosol generating material is a aerosol generating film.

21. A product according to claim 19 in which at least one consumable element comprises at least two discrete portions of aerosol generating material, and at least two discrete portions of aerosol generating material have different compositions to each other.

22. A product according to claim 19 in which at least one consumable element comprises a support, and the support supports the aerosol generating material.

23. A product according to claim 22 in which the support is a sheet material and the aerosol generating material is an aerosol generating material film.

24. A product according to claim 22 in which the support is a metal foil or a metallic foil.

25. A product according to claim 22 in which the aerosol generating material substantially covers or wholly covers one surface of the support.

26. A product according to claim 22 in which at least a portion of the support is releasably attached to a portion of the carrier.

27. A product according to claim 22 in which at least one portion of aerosol generating material is supported on the support, and at least one portion of the aerosol generating material is located between the support and the portion of the carrier which supports the consumable element.

28. A product according to claim 22 in which at least one portion of aerosol generating material is supported on the support, and the support is between at least one portion of the aerosol generating material and the portion of the carrier which supports the consumable element.

29. A product according to claim 1 in which the consumable element comprises a susceptor.

30. A product according to claim 22 in which the support comprises a susceptor.

31. A product according to claim 1 in which the carrier comprises a susceptor.

32. A product according to claim 29 in which the susceptor comprises a metallic foil.

33. A product according to claim 1 in which at least one of the consumable elements is releasably supported on the carrier.

34. A product according to claim 33 in which at least one of the consumable elements may be released from the carrier without damage to that consumable element.

35. A product according to claim 1 in which at least one of the consumable elements is supported on the carrier by adhesion.

36. A product according claim 35 in which, in which the adhesion is caused by a releasable adhesive.

37. A product according to claim 36 in which the releasable adhesive is a pressure sensitive adhesive.

38. A product according to claim 35 in which the carrier has at least one carrier attachment surface to which at least one consumable element is attached, the consumable element has a consumable element attachment surface which is attached to the carrier attachment surface, and the carrier attachment surface and consumable element attachment surface have surface characteristics which result in the cause for the adhesion of the consumable element to the carrier remaining on the carrier attachment surface when the consumable element is removed from the carrier attachment surface.

39. A product according to claim 35 in which the carrier has at least one carrier attachment surface to which at least one consumable element is attached, the consumable element has a consumable element attachment surface which is attached to the carrier attachment surface, and the carrier attachment surface and consumable element attachment surface have surface characteristics which result in the cause for the adhesion of the consumable element to the carrier remaining on the consumable element attachment surface when the consumable element is removed from the carrier attachment surface.

40. A method of making a product according to claim 1 in which the method comprises
providing a carrier, and
forming at least one consumable element on the carrier.

41. A method of making a product according to claim 1 in which the method comprises
providing a carrier, and
adhering at least one preformed consumable element to the carrier.

42. A method according to claim 40 in which the carrier is separated from a body of carrier material before or after forming at least one consumable element on the carrier or adhering at least one preformed consumable element to the carrier.

43. A kit for making a consumable for use with an apparatus for heating an aerosol generating material, in which the kit comprises at least one support and at least one product according to claim 1.

44. A kit according to claim 43 in which the support is reusable.

45. A method of making a consumable for use with an apparatus for heating an aerosol generating material in which the method comprises removing a consumable element from a product according to claim 1, and attaching the consumable element to a support.

46. A method of making a consumable for use with an apparatus for heating an aerosol generating material in which the method comprises
providing a product according to claim 1, and
separating a portion of the product from the remainder of the product, in which the separated portion of the product comprises a portion of the carrier and at least one consumable element.

47. An aerosol provision system comprising an aerosol provision device and a kit according to claim 43, in which the aerosol provision device comprises a aerosol generator configured to heat at least a portion of the aerosol generating material supported on a consumable.

48. A method of generating aerosol from a consumable made using the kit according to claim 43, the method including using an aerosol generating device with at least one aerosol generator disposed to heat, but not burn, the consumable in use; wherein at least one aerosol generator is a resistive heater element or a magnetic field generator and a susceptor.
